(19) United States
(12) Patent Application Publication
(10) Pub. No.: US 2019/0170010 A1
(43) Pub. Date: Jun. 6, 2019

(54) METHODS, SYSTEMS AND APPARATUS RELATING TO TURBINE ENGINE EXHAUST DIFFUSERS

(71) Applicant: General Electric Company, Schenectady, NY (US)

(72) Inventors: Peter Joachim Stein, Regensdorf (CH); Prakash Durairaj, Rugby (GB); Dominik Born, Oensingen (CH)

(73) Assignee: General Electric Company, Schenectady, NY (US)

(21) Appl. No.: 15/830,073

(22) Filed: Dec. 4, 2017

(51) Int. Cl. F01D 17/16; F01D 25/30; F01D 5/02

(52) U.S. Cl. CPC F01D 17/162; F05D 2240/60; F01D 5/02; F01D 25/30

(57) ABSTRACT

A turbine engine having a turbine section operably connected to an exhaust section, through which an exhaust flowpath is defined. The exhaust section includes a diffuser having a diffuser flowpath. The turbine engine further includes: diffuser walls that define and enclose the diffuser flowpath between an inlet and outlet of the diffuser, the diffuser walls comprising at least one stationary diffuser wall and at least one adjustable diffuser wall; and an actuator connected to the at least one adjustable diffuser wall. The actuator is configured to move the at least one adjustable diffuser wall in relation to the at least one stationary diffuser wall along an axis of movement that causes a modification to a cross-sectional flow area through the diffuser flowpath.

### BACKGROUND OF THE INVENTION

This present application relates generally to turbine engines. More specifically, but not by way of limitation, the present application relates to exhaust diffusers for such turbine engines.

In turbine engines, an exhaust flow exiting the turbine or turbine section via the last row of turbine blades is typically directed through a diffuser, which, in general, is an outwardly flared flow passage of increasing cross-sectional area. Within a steam turbine engine, for example, the purpose of a diffuser is to lower the pressure of the steam exhaust at the exit of the turbine section so to, thereby, increase the amount of energy available to the last stage of rotor blades. Specifically, as a result of the increasing cross-sectional area through the diffuser, diffusion or deceleration occurs as the exhaust steam passes therethrough. This deceleration causes a decrease in the kinetic energy of the steam and an increase in pressure, with the desired net effect being that, at the inlet or upstream end of the diffuser, the exhaust steam has the lowest pressure within the diffuser flowpath, for example, between the turbine section and a condenser. With this achieved, the steam exhaust enters the diffuser a minimum pressure occurring just downstream of the last row of rotor blades and, thus, maximizes the velocity of steam flowing through those rotor blades and maximized the energy available to the turbine engine to do work.

From this minimum pressure, it is desirable for the diffuser to produce a steep rise in pressure or pressure recovery. However, the amount of diffusion a diffuser can produce is limited by the pressure gradient along the length of the diffuser, which is generally defined as the ratio of the pressure rise to diffuser length. Such pressure rise thus depends on the exit-to-inlet flow area ratio of the diffuser. As will be appreciated, if the pressure gradient becomes too large—for example, the walls of the diffuser diverge too steeply—the steam flow separates from the walls of the diffuser and the rate of diffusion can be seriously reduced, which negatively impacts performance. There is, therefore, a continuing need for improved methods and configuration related to diffusers and the operation thereof.

### BRIEF DESCRIPTION OF THE INVENTION

The present application thus describes a turbine engine having a turbine section operably connected to an exhaust section, through which an exhaust flowpath is defined. The exhaust section includes a diffuser having a diffuser flowpath. The turbine engine further includes: diffuser walls that define and enclose the diffuser flowpath between an inlet and outlet of the diffuser, the diffuser walls comprising at least one stationary diffuser wall and at least one adjustable diffuser wall; and an actuator connected to the at least one adjustable diffuser wall. The actuator is configured to move the at least one adjustable diffuser wall in relation to the at least one stationary diffuser wall along an axis of movement that causes a modification to a cross-sectional flow area through the diffuser flowpath.

These and other features of the present application will become apparent upon review of the following detailed description of the preferred embodiments when taken in conjunction with the drawings and the appended claims.

### BRIEF DESCRIPTION OF THE DRAWINGS

These and other objects and advantages of this invention will be more completely understood and appreciated by careful study of the following more detailed description of exemplary embodiments of the invention taken in conjunction with the accompanying drawings, in which:

FIG. 1 is a schematic cross-sectional side view of the downstream or aft end of a turbine engine and an exemplary conventional diffuser;

FIG. 2 is a simplified cross-sectional view of a diffuser within which aspects of the present application may be practiced;

FIG. 3 is a simplified cross-sectional view of an exemplary diffuser in accordance with aspects of the present invention;

FIG. 4 is a simplified cross-sectional view of an exemplary diffuser in accordance with aspects of the present invention;

FIG. 5 is a simplified cross-sectional view of an exemplary diffuser in accordance with aspects of the present invention; and

FIG. 6 illustrates a side-by-side cross-sectional comparison of calculated flow data for low exit velocity conditions between a conventionally operating diffuser and a diffuser of the present invention operating with the downstream axial section of the inboard wall adjusted in the upstream direction, along with a plot of calculated data taken across a range of exit velocities.

### DETAILED DESCRIPTION OF THE INVENTION

Aspects and advantages of the present application are set forth below in the following description, or may be obvious from the description, or may be learned through practice of the invention. Reference will now be made in detail to present embodiments of the invention, one or more examples of which are illustrated in the accompanying drawings. The detailed description uses numerical designations to refer to features in the drawings. Like or similar designations in the drawings and description may be used to refer to like or similar parts of embodiments of the invention. As will be appreciated, each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. It is intended that the present invention covers such modifications and variations as come within the scope of the appended claims and their equivalents. It is to be understood that the ranges and limits mentioned herein include all sub-ranges located within the prescribed limits, inclusive of the limits themselves unless otherwise stated.

Additionally, certain terms have been selected to describe the present invention and its component subsystems and parts. To the extent possible, these terms have been chosen based on terminology common to the technology field. Still, it will be appreciated that such terms often are subject to differing interpretations. For example, what may be referred to herein as a single component, may be referenced elsewhere as consisting of multiple components, or, what may be referenced herein as including multiple components, may be referred to elsewhere as being a single component. Thus, in understanding the scope of the present invention, attention should not only be paid to the particular terminology used, but also to the accompanying description and context, as well as the structure, configuration, function, and/or usage of the component being referenced and described, including the manner in which the term relates to the several figures, as well as, of course, the usage of the terminology in the appended claims.

The following examples are presented in relation to particular types of turbine engines. However, it should be understood that the technology of the present application may be applicable to other categories of turbine engines, without limitation, as would be appreciated by a person of ordinary skill in the relevant technological arts. Accordingly, unless otherwise stated, the usage herein of the term “turbine engine” is intended broadly and without limiting the usage of the claimed invention with different types of turbine engines, including various types of combustion or gas turbine engines as well as steam turbine engines.

Given the nature of how turbine engines operate, several terms may prove particularly useful in describing certain aspects of their function. For example, the terms “downstream” and “upstream” are used herein to indicate position within a specified conduit or flowpath relative to the direction of flow or “flow direction” of a fluid moving through it. Thus, the term “downstream” refers to the direction in which a fluid is flowing through the specified conduit, while “upstream” refers to the direction opposite that. These terms should be construed as referring to the flow direction through the conduit given normal or anticipated operation. Given the configuration of turbine engines, particularly the arrangement of the components about a common or central shaft or axis, terms describing position relative to an axis may be used regularly. In this regard, it will be appreciated that the term “radial” refers to movement or position perpendicular to an axis, for example, the center or central axis of the turbine engine. Related to this, it may be required to describe relative distance from the central axis. In such cases, for example, if a first component resides closer to the central axis than a second component, the first component will be described as being either “radially inward” or “inboard” of the second component. If, on the other hand, the first component resides further from the central axis than the second, the first component will be described as being either “radially outward” or “outboard” of the second component. As used herein, the term “axial” refers to movement or position parallel to the central axis, while the term “circumferential” refers to movement or position around the central axis. Unless otherwise stated or made apparent by context, these terms should be construed as relating to the center or central axis of the turbine (also “turbine central axis”) as defined by the central shaft extending therethrough, even when these terms are describing or claiming attributes of non-integral components—such as rotor or stator blades—that function therein. Finally, the term “rotor blade” is a reference to the blades that rotate about the turbine central axis during operation, while the term “stator blade” is a reference to the blades that remain stationary.

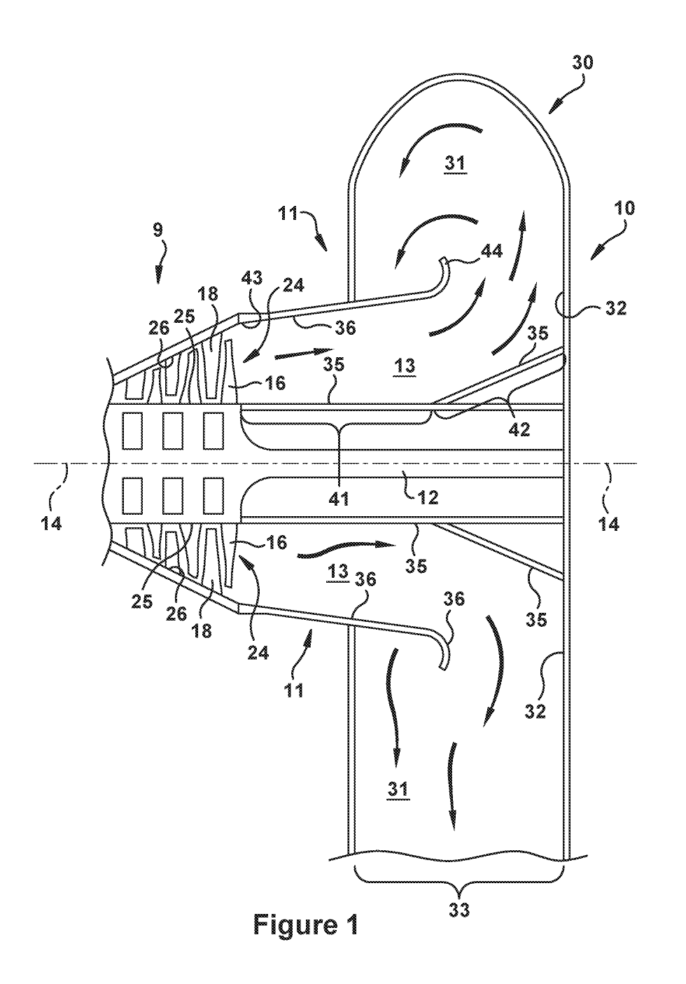

Referring now to the drawings, for background purposes, FIG. 1 shows a portion of a turbine section 9 of a turbine engine that is operably connected to an exhaust section 10. The exhaust section 10 may include a diffuser 11 having a conventional design. The turbine section 9 and exhaust section 10, for example, may be part of a steam turbine engine. As illustrated, the turbine section 9 may include a shaft 12 that includes rotor wheels on which is mounted a plurality of circumferentially arrayed rotating buckets or rotor blades 16. The shaft 12 defines what will be referred to as the central axis 14 of the turbine, which is the axis around which the turbine section 9 and diffuser 11 are formed. As shown, multiple axially stacked rows of the rotor blades 16 may be provided within the turbine section 9, with intervening rows of stationary nozzles or stator blades 18 being placed between them. Thus, the turbine section 9 may include axially stacked rows of blades 16, 18, which are alternated such that, within each stage, a row of stator blades 18 leads a row of rotor blades 16.

The rotor and stator blades 16, 18 generally reside within an annular shaped working fluid flowpath 24 that is defined through the turbine section 9. As will be appreciated, the working fluid flowpath 24 guides a working fluid—such as steam or, in the case of a combustion turbine engine, combustion gases—onto the blades 16, 18. As indicated, the boundaries of the annular working fluid flowpath 24 are defined by concentrically formed inboard and outboard walls 25, 26. In operation, a pressurized working fluid is expanded through the working fluid flowpath 24 of the turbine section 9. The stator blades 18 direct this flow of working fluid onto the rotor blades 16 so to induce the rotor blades 16 to rotate. This rotation is translated to the shaft 12, and, in this way, the energy of the flow of working fluid is transformed into the mechanical energy the rotating shaft 12, which then may be used in a variety of applications, for example, to rotate the coils of a generator to produce electricity.

It will be appreciated that, once it is expelled from the working fluid flowpath 24 of the turbine section 9, the working fluid is directed into the exhaust section 10. As used herein, once the working fluid exits the turbine section 9 and enters the exhaust section 10, it may be referred to as exhaust. Steam turbine engines—as well as combustion turbine engines—typically include diffusers 11 within the exhaust section 10. In general, diffusers 11 are outwardly flared annular passages of increasing cross-sectional flow area. Within a steam turbine engine, for example, the purpose of a diffuser 11 is to lower the pressure of the exhaust at the exit of the turbine section 9 so to increases the amount of energy available to the last stage of rotor blades. More specifically, as a result of the increasing cross-sectional flow area, diffusion or deceleration occurs as the exhaust passes through the diffuser 11. This deceleration of the exhaust causes a decrease in the kinetic energy and an increase in pressure, with the desired net effect being that, at the inlet or upstream end of the diffuser 11, the exhaust has the lowest pressure level along the path through the diffuser 11. This allows the working fluid exiting the last stage of rotor blades 16 to enter the diffuser 11 at a minimum pressure level, thus maximizing the velocity of working fluid flowing through the last stage of rotor blades 16 and increasing the output of the engine.

From this minimum pressure level at the inlet of the diffuser 11, it is desirable for the diffuser 11 to induce a rapid recovery in pressure. However, the amount of diffusion possible within a diffuser 11 is limited by the longitudinal pressure gradient therewithin, which is generally defined as the ratio of the pressure rise to the length of the diffuser 11, and such pressure rise typically depends on the exit-to-inlet area ratio of the diffuser 11. As will be seen, if the pressure gradient becomes too large—for example, when the walls of the diffuser diverge too steeply from each other—the exhaust flow will separate from the walls of the diffuser 11, and this will negatively impact diffuser performance. More specifically, adverse pressure gradients in the diffusing passage can cause boundary layer growth and stall, which generally leads to the exhaust flow separating from the diffuser walls and causing pressure losses that degrade performance.

As shown in FIG. 1, a diffuser 11 may generally form a diverging annular shaped diffuser flowpath 13 that enlarges in cross-sectional flow area as it extends axially in the downstream direction. The diffuser flowpath 13 of the diffuser 11 generally receives exhaust—which, as will be appreciated, constitutes the working fluid that is exiting the turbine section 9—via an upstream end or inlet and then delivers that exhaust via a downstream end or outlet to another exhaust path component, which will be referred to herein as a collector 30. The collector 30 may define a collector flowpath 31. Thus, the exhaust section 10 may have an exhaust flowpath that includes an upstream section, which is defined by the diffuser flowpath 13 of the diffuser 11, and a downstream section, which is defined by the collector flowpath 31 of the collector 30.

As shown, the collector flowpath 31 may be configured so to deflect or turn the exhaust approximately 90 degrees. The collector flowpath 31 then directs the exhaust toward a desired downstream outlet 33 where it may be directed to another component. The collector 30 may include a backwall 32 that approximately opposes the outlet of the diffuser 11. The backwall 32 may be oriented approximately perpendicular to the central axis 14 and, thus, deflect the exhaust exiting the diffuser 11 in a direction that is approximately perpendicular to the central axis 14. As indicated by the flow arrows of FIG. 1, the turning of the exhaust may be initiated by a conical section within the diffuser 11 and then completed within the collector 30. Thusly, the exhaust is turned from a flow that is generally parallel with the central axis 14 (as is the case as the exhaust enters the diffuser 11) to one that is generally perpendicular to the central axis 14 (as is the case once that exhaust is turned within the collector 30). The backwall 32, as shown, of the collector 30 may include a surface that is oriented approximately perpendicular to the central axis 14. The backwall 32 generally turns the flow of exhaust, as described, while the other boundary walls of the collector 30 direct the exhaust toward the outlet 33. From the outlet 33 of the collector, the exhaust may be directed to a downstream component, such as, for example, a condenser.

The diffuser 11 is composed of several walls that define and enclose the annular shaped flowpath 13 defined through it, which will now be described. As will be seen, these walls generally extend: axially between upstream and downstream ends; and circumferentially 360 degrees about the central axis 14. One way in which these walls may be differentiated is according to their concentric arrangement, in which an inboard wall 35 is surrounded by an outboard wall 36. More specifically, as indicated, the diffuser 11 includes an inboard wall 35, which defines an inboard boundary of the diffuser flowpath 13, and an outboard wall 36, which defines an outboard boundary of the diffuser flowpath 13.

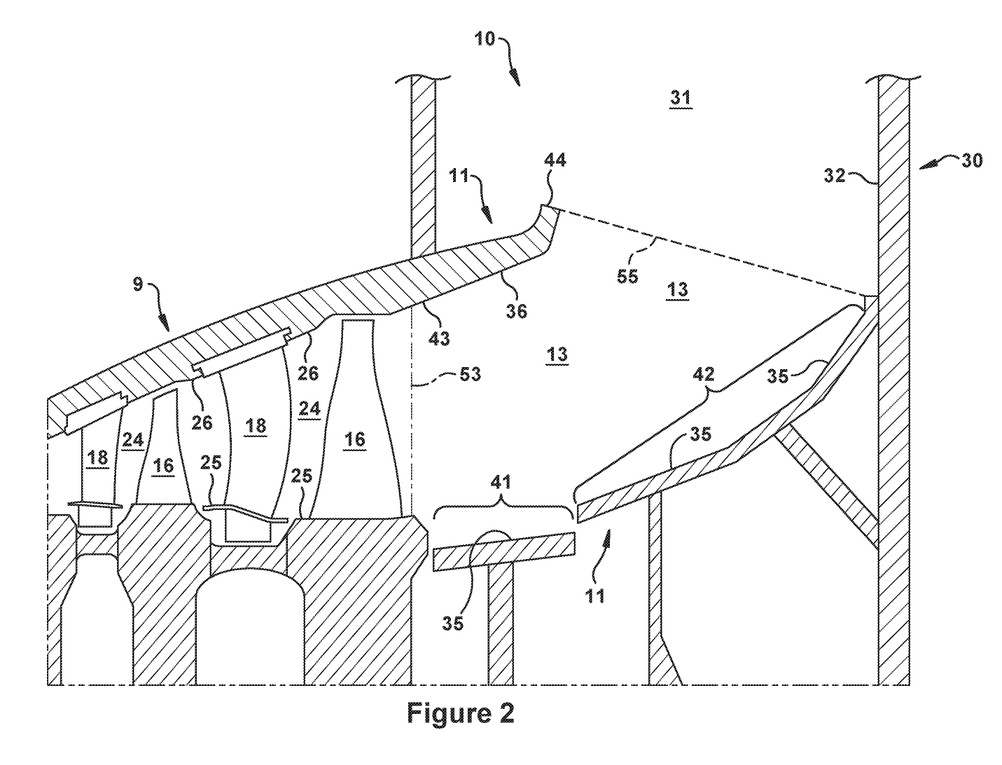

In regard to the inboard wall 35 of the diffuser 11, for purposes herein, it may be described as having two axially stacked and adjacent sections, which will be referred to as: an upstream axial section 41, which may be oriented approximately parallel to the central axis 14; and a conical or downstream axial section 42, which is angled or canted in relation to the central axis 14. The upstream axial section 41 resides upstream of the downstream axial section 42 in relation to the flow direction of exhaust through the diffuser 11. The upstream axial section 41 is generally formed having the shape of a cylinder that wraps about the shaft 12 or central axis 14 of the turbine engine. As shown below in relation to FIGS. 2 through 5, the upstream axial section 41 also may have a conical or truncated cone shape. Axially, as shown, the upstream axial section 41 extends between an upstream end, which may be adjacent or connected to the inboard wall 25 of the working fluid flowpath 24, and a downstream end, which may be adjacent to the downstream axial section 42.

As shown, the conical or downstream axial section 42 of the diffuser 11 may take the shape of a truncated cone. The downstream axial section 42 may be oriented such that the smaller diameter end of the truncated cone shape is positioned upstream relative to the larger diameter end. The downstream axial section 42 may be radially symmetrical about a longitudinal axis defined through the central axis 14. Axially, the downstream axial section 42 extends between an upstream end, which is adjacent or connected to the upstream axial section 41, and a downstream end, which may be adjacent or connected to the backwall 32 of the collector 30. The truncated cone shape may initiate the turning of the exhaust in anticipation of the backwall 32 of the collector 30. In this way, the turning of the exhaust within the exhaust section 10 is more gradual, which reduces turbulent flow that may otherwise negatively impact performance. Thus, the downstream axial section 42 generally extends 360 degrees circumferentially about the central axis 14, and enlarges in diameter as it extends axially in the downstream direction, thereby forming its truncated cone shape, which may terminate at or near the backwall 32 of the collector 30.

In the case of the outboard wall 36 of the diffuser 11, it also may have a conical shape, which extends in the downstream direction between an upstream end 43, which may be smaller in diameter, and a downstream end 44, which may be larger in diameter. More specifically, the outboard wall 36 may be shaped as a truncated cone, with the smaller diameter end of the truncated cone shape being positioned upstream relative to the larger diameter end. The truncated cone shape of the outboard wall 36 may be radially symmetrical about a longitudinal axis defined approximately by the central axis 14. Additionally, the upstream end 43 of the outboard wall 36 may be adjacent or connected to the outboard wall 26 of the working fluid flowpath 24 of turbine section 9, while the downstream end 44 extends into the collector 30. It should be understood that the outboard wall 36 extends circumferentially 360 degrees about the central axis 14 and, thereby, forms the truncated cone shape that is oriented so that it enlarges axially between its upstream and downstream ends 43, 44. As indicated, the downstream end 44 may include a curved or flared lip. This flared lip may include an outwardly curving piece, which is configured in this manner for guiding or turning the exhaust into the collector 30.

Turning to FIG. 2, an enhanced cross-sectional view of an alternative diffuser 11 is provided, which has been labeled using the same numeral identifiers introduced in FIG. 1. The exemplary diffuser 11 of FIG. 2 will be used as a template in several of the figures that follow to describe certain aspects the present invention. As designated in relation to the expected flow direction of exhaust through the diffuser 11, dashed lines have been added to illustrate an upstream end of the diffuser 11, which will be referred to herein as an inlet 53, and a downstream end of the diffuser 11, which will be referred to herein as an outlet 55. As will be appreciated, the inlet 53 of the diffuser 11 is configured to accept the working fluid exiting the turbine section 9. The turbine section 9 includes a last row of rotor blades 16 positioned just upstream of the inlet 53 of the diffuser 11. In relation to this last row of rotor blades 16, the inlet 53 and the upstream portion of the diffuser flowpath 13 contiguous to the inlet 53 form what will be referred to herein as an “exit area”, in that this is the area first encountered by the working fluid exiting the last row of the rotor blades 16. In regard to the downstream end of the diffuser flowpath 13, the outlet 55 discharges the exhaust moving through diffuser 11 into the collector 30. As shown, between the inlet 53 and outlet 55, the cross-sectional flow area through the diffuser flowpath 13 gradually enlarges.

As also shown in FIGS. 2 through 5, instead of the cylindrical shape described above, the upstream axial section 41 of the inboard wall 35 may be configured with a conical shape or truncated cone shape, which is oriented to such that the diameter of the truncated cone shape increases in the downstream direction. As shown, the conical shape of the upstream axial section 41 may have a shallower angle relative to the central axis 14 than that of the conically shape of the downstream axial section 42. It should be appreciated that the present invention may be practiced with the upstream axial section 41 having either a cylindrical or conical shape.

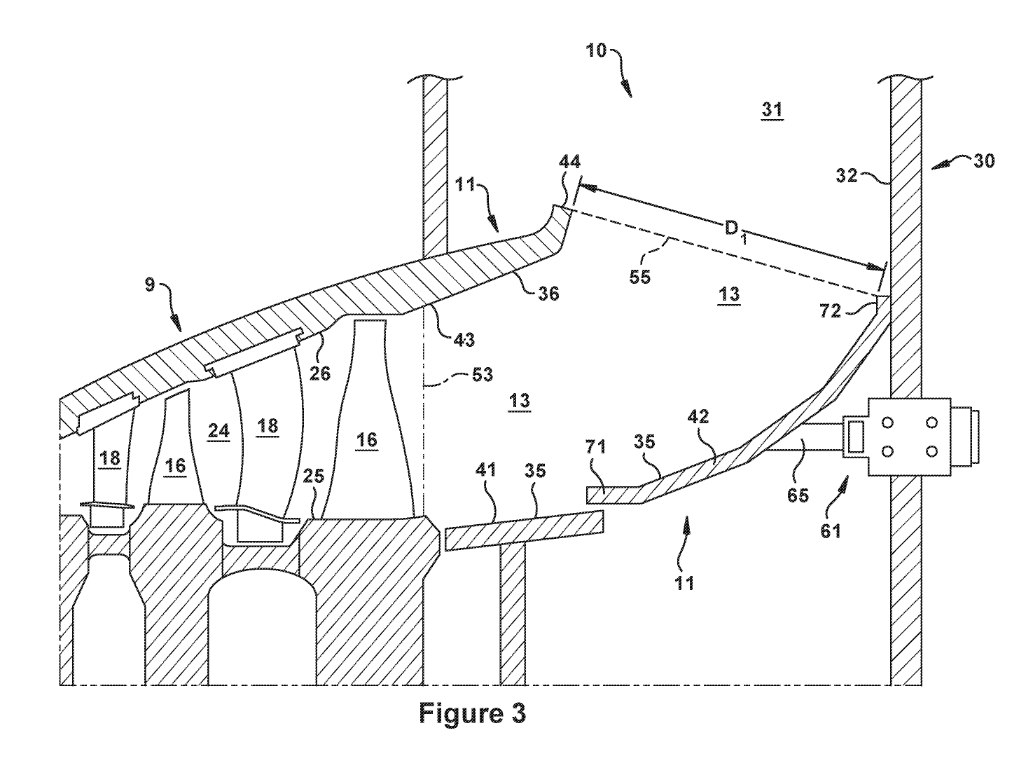

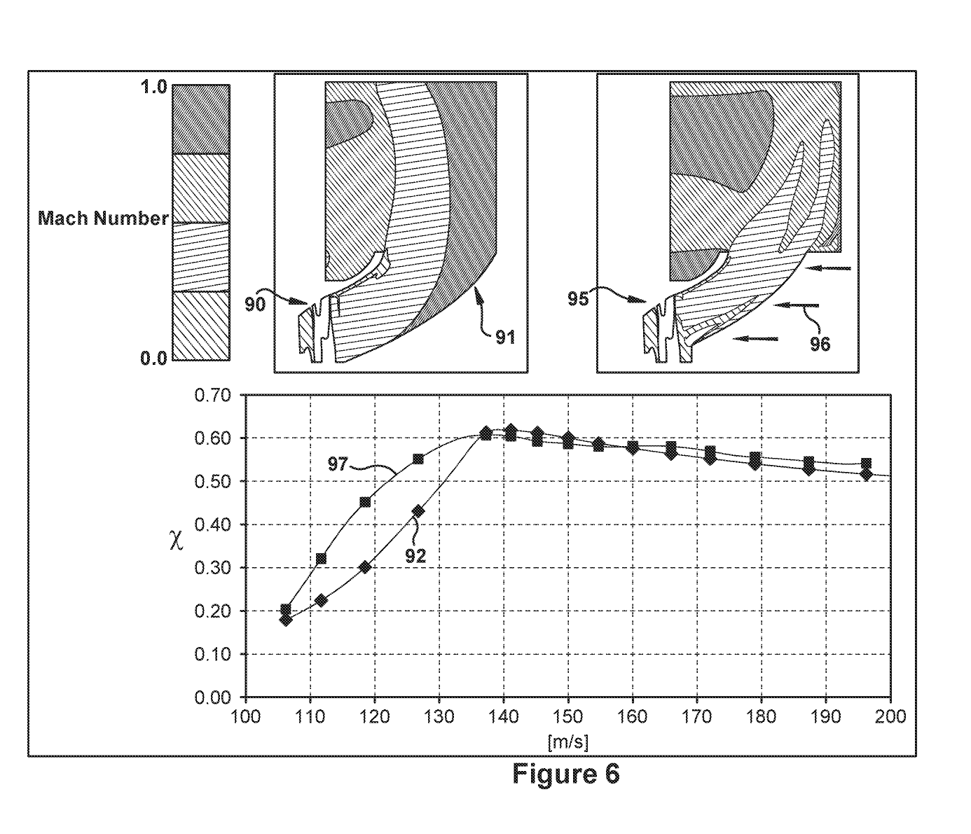

With specific reference now to FIGS. 3 through 5, in accordance with embodiments of the present invention, a diffuser is described that has an adaptive or adjustable wall, the movement of which is controlled to modify the cross-sectional flow area through the diffuser flowpath. As will be seen, such modification to the diffuser flowpath may include narrowing and/or widening the diffuser outlet. Additionally, the modification of the diffuser flowpath may include narrowing and/or widening the diffuser inlet and the upstream portion of the diffuser, which, as defined above, represents an “exit area” in relation to the last stage of rotor blades. Further, according to preferred embodiments, the narrowing and/or widening may be done in response to the detection of a predefined operating condition, such as a low flow volume conditions or low exit velocity from the last stage of the rotor blades. As will be appreciated, when these conditions occur, the exhaust within the diffuser tends to separate from the diffuser walls, and this can cause a strong drop in pressure recovery and negatively affect power output from the last stage of rotor blades. Further, such conditions can make the exhaust begin to recirculate in the area just downstream of the last row of rotor blades—the above-described “exit area”—which is a result that can massively cut power output from the last row of rotor blades. As will be seen, in accordance with the present invention, if the conical section of the diffuser inboard wall is adjusted or repositioned axially when these conditions are satisfied, such flow separation and recirculation can be avoided and, hence, pressure recovery and power output significantly improved. As discussed below in relation to FIG. 6, the enthalpy recovery curve of the last stage of rotor blades generally includes a strong gradient at low volume flow conditions, which means the beneficial effect that the present invention has on power output is potentially sizeable.

In describing the present invention, several of the terms and concepts will be used in the same manner as they were in introducing the conventional systems of FIGS. 1 and 2. For example, it should be understood that the working fluid flowpath 24 is annularly shaped and defined between inboard and outboard walls 25, 26. Similarly, the diffuser flowpath 13 also is annularly shaped and defined between inboard and outboard walls 35, 36. Such inboard walls 25, 35 and outboard walls 26, 36 of the working fluid and diffuser flowpaths, respectively, are arranged concentrically about a central axis 14 that is defined through the turbine shaft 12. Additionally, upstream and downstream directions through the working fluid flowpath 24 and the diffuser flowpath 13 are defined in relation to flow directions therethrough of the working fluid and the exhaust, respectively.

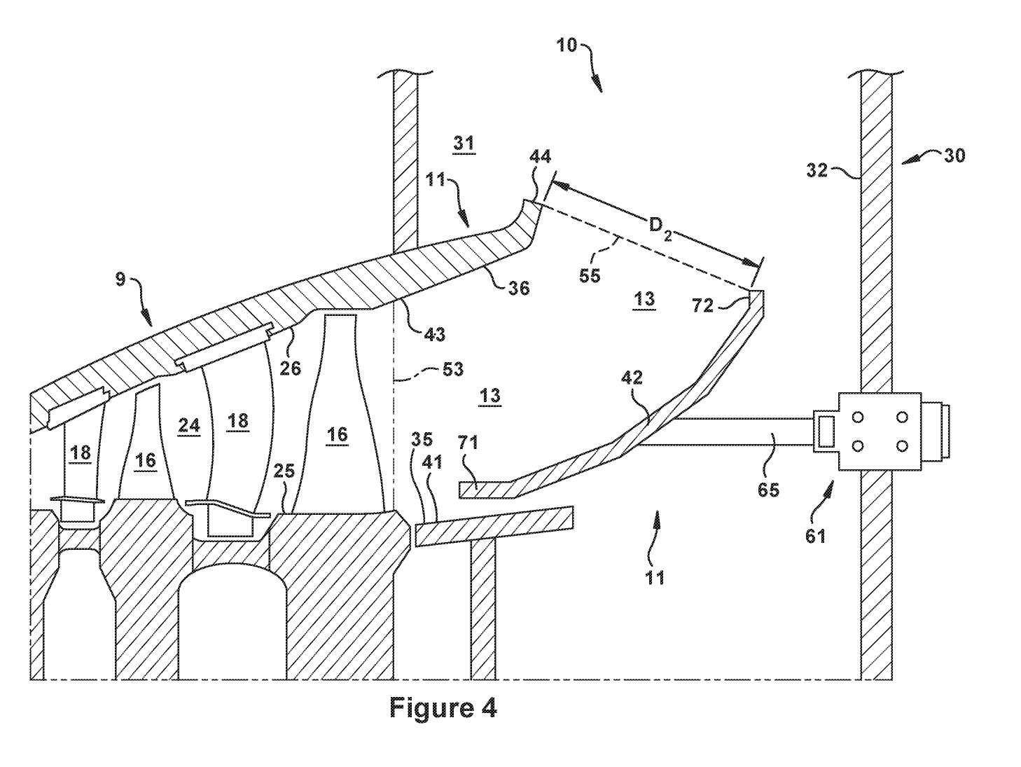

As shown in FIGS. 3 and 4, in accordance with the present invention, the diffuser 11 includes several walls (also “diffuser walls”) that define and enclose the diffuser flowpath 13 between an inlet 53 and outlet 55. As will be seen, the present invention includes configuring at least one of these diffuser walls as an adaptive or adjustable diffuser wall and at least one of the diffuser walls as a stationary diffuser wall. As also shown, an actuator 61 may be provided for adjusting or moving the adjustable diffuser wall. The actuator 61 may include any conventional apparatus or structure for achieving the controlled movement described herein. The adjustable diffuser wall—which, as shown, may be the downstream axial section 42 of the inboard wall 35—may be connected to the actuator 61 via any conventional structural arrangement—such as by an arm 65. The actuator 61 and arm 65 may function to move the adjustable diffuser wall in relation to the stationary diffuser wall between two or more positions. Such movement may be effected along a particular axis of movement, which is chosen so that the flow area through the diffuser flowpath 13 is modified in a desirable way. As will be seen, such modification to the flow area through the diffuser flowpath 13 may be one that alternatively narrows and widens the outlet 55 of the diffuser 11.

In addition, given the configuration of the adjustable diffuser wall, the modification to the flow area through the diffuser flowpath 13 may be one that also narrows and widens the inlet 53 of the diffuser 11 and/or upstream areas within the diffuser flowpath 13. As will be appreciated, these upstream areas within the diffuser flowpath 13 represent an immediate exit area for the working fluid moving through and exiting the last stage of rotor blades. At very low volume flow conditions, flow separation within this exit area can cause a recirculation that negatively reacts on the airfoils of the rotor blades to cause a massive loss in power. As will be seen, the axial readjusting of the conical section of the inboard wall may narrow this “exit area” of the last stage of rotor blades and prevent this recirculation. The present invention also may be used to avoid low volume flow excitations of the last stage of rotor blades. Hence, it should be understood that the present invention may be used to both: 1) modify (reduce/enlarge) the diffuser area ratio by narrowing the outlet of the diffuser; and 2) modify (reduce/enlarge) the flow area through the inlet 53 and upstream areas of the diffuser 11 so to modify the exit area of the working fluid moving through the last stage of rotor blades.

According to exemplary embodiments, generally, the stationary diffuser wall of the diffuser 11 includes the outboard wall 36 of the diffuser 11, while the adjustable diffuser wall includes the inboard wall 35 of the diffuser 11. For purposes herein, one way in which the outlet 55 of the diffuser 11 is dimensionally defined is as the distance occurring between: a downstream most termination point or end of the outboard wall 36 of the diffuser 11 and a downstream most termination point or end of the inboard wall 35 of the diffuser. In the FIGS. 3 through 6, it will be appreciated that the downstream most end of the outboard wall 36 is designated by the numeral identifier 44 and the downstream most end of the inboard wall 35 is designated by the numeral identifier 72.

According to an exemplary embodiment, the actuator 61 is configured to move the adjustable diffuser wall so to effectuate a narrowing of the diffuser flowpath 13, generally, and, more specifically, a narrowing of the distance between the downstream most end of the outboard wall 36 and the downstream most end of the inboard wall 35. The actuator 61 may be configured to move the adjustable diffuser wall through a range of positions occurring between a fully open condition and a fully narrowed condition. The movement over that range may be between preset intervals within that range or, alternatively, smoothly so that virtually any position within that range is attainable. At minimum, the present invention includes the actuator 61 being configured to move the adjustable diffuser between at least a first position (as depicted in FIG. 3), in which the outlet 55 of the diffuser 11 is wide or in a fully open position, and a second position (as depicted in FIG. 4), in which the outlet 55 has been narrowed. More specifically, in the first position of FIG. 3, the downstream most end of the inboard wall 35 of the diffuser 11 resides a first distance (D₁) from the downstream most end of the outboard wall 36 of the diffuser 11. Whereas, in the second position of FIG. 4, the section of the inboard wall 35 connected to the actuator 61 has been axially relocated so that the downstream most end of the inboard wall 35 of the diffuser 11 resides a second (and comparatively shorter) distance (D₂) from the downstream most end of the outboard wall 36 of the diffuser 11. According to exemplary embodiments, the second distance represents a significant reduction compared to the first distance. This, as illustrated, results in the outlet 55 of the diffuser 11—as well as other portions of the diffuser 11—being appreciably narrowed so to materially affect diffusion performance therewithin. The extent of this narrowing may be variable depending on many factors, such as desired performance as well as the overall configuration of the diffuser. According to certain preferred embodiments, the first distance is at least 1.25 times the second distance.

As discussed above, the inboard wall 35 of the diffuser 11 may be more specifically described in relation to certain axially defined sections, which include an upstream axial section 41 and a downstream axial section 42. As shown in FIG. 1, the upstream axial section 41 of the inboard wall 35 may be in the shape of a cylinder or may have a conical or truncated cone shape (as shown in FIGS. 2 through 5. The downstream axial section 42 of the inboard wall may have a conical or truncated cone shape. The upstream axial section 41 of the inboard wall 35 extends between an upstream end, which is disposed adjacent to the inboard wall 35 of the working fluid flowpath, and a downstream end, which is disposed adjacent to the downstream axial section 42. The downstream axial section 42 of the inboard wall 35 extends generally between an upstream end 71, which is disposed adjacent to the upstream axial section 41 of the inboard wall 35, and a downstream end 72, which, as shown in FIGS. 3 and 4, may be disposed adjacent to the backwall 32 of the collector 30 or offset therefrom depending on the current position of the adjustable diffuser wall.

As will be appreciated, the truncated cone shape of the downstream axial section 42 of the inboard wall 35 is radially symmetrical about a longitudinal axis defined approximately at the central axis, with the truncated cone shape enlarging in diameter between a smaller diameter end and a larger diameter end. Thus, the upstream end 71 of the downstream axial section 42 of the inboard wall 35 includes the smaller diameter end of the truncated cone shape, while the downstream end 72 of the downstream axial section 42 of the inboard wall 35 includes the larger diameter end of the truncated cone shape.

The outboard wall 36 of the diffuser walls also may have a truncated cone shape that is radially symmetrical about a longitudinal axis defined approximately at the central axis 14. The truncated cone shape of the outboard wall 36, as illustrated, enlarges in diameter between a smaller diameter end and a larger diameter end, where an upstream end 43 of the outboard wall 36 includes the smaller diameter end of the truncated cone shape while the downstream end 44 of the outboard wall 36 includes the larger diameter end of the truncated cone shape. The outboard wall 36 may be configured to extend between an upstream end 43, which is adjacent to the outboard wall 26 of the working fluid flowpath 24, and a downstream end 44.

Given this more detailed description of the diffuser flowpath 13, in accordance with certain embodiments of the present invention, the stationary diffuser wall of the diffuser 11 may be more particularly identified as being both the outboard wall 36 and the upstream axial section 41 of the inboard wall 35. And, the adjustable diffuser wall of the diffuser 11 of the present invention may be more particularly identified as being the downstream axial section 42 of the inboard wall 35. Pursuant to this more detailed description, an outlet width dimension may be introduced that describes the cross-sectional flow area through the outlet 55 of the diffuser 11. As indicated in FIGS. 3 and 4, the outlet width is the distance occurring between the downstream end 44 of the outboard wall 36 and the downstream end 72 of the downstream axial section 42 of the inboard wall 35, which is depicted in FIGS. 3 and 4 as D₁ and D₂, which were previously referenced as first and second distances, respectively. In moving between the two different positions portrayed in FIGS. 3 and 4, the outlet width of the diffuser outlet 55 is varied between wider and narrower instances. According to preferred embodiments, as indicated above, the outlet width (D₂) of FIG. 4 is one that is significantly reduced compared to the outlet width (D₁) of FIG. 3. For example, according to preferred embodiments, the outlet width (D₁) of FIG. 3 may be described as being at least 1.25 times the outlet width (D₂) of FIG. 4.

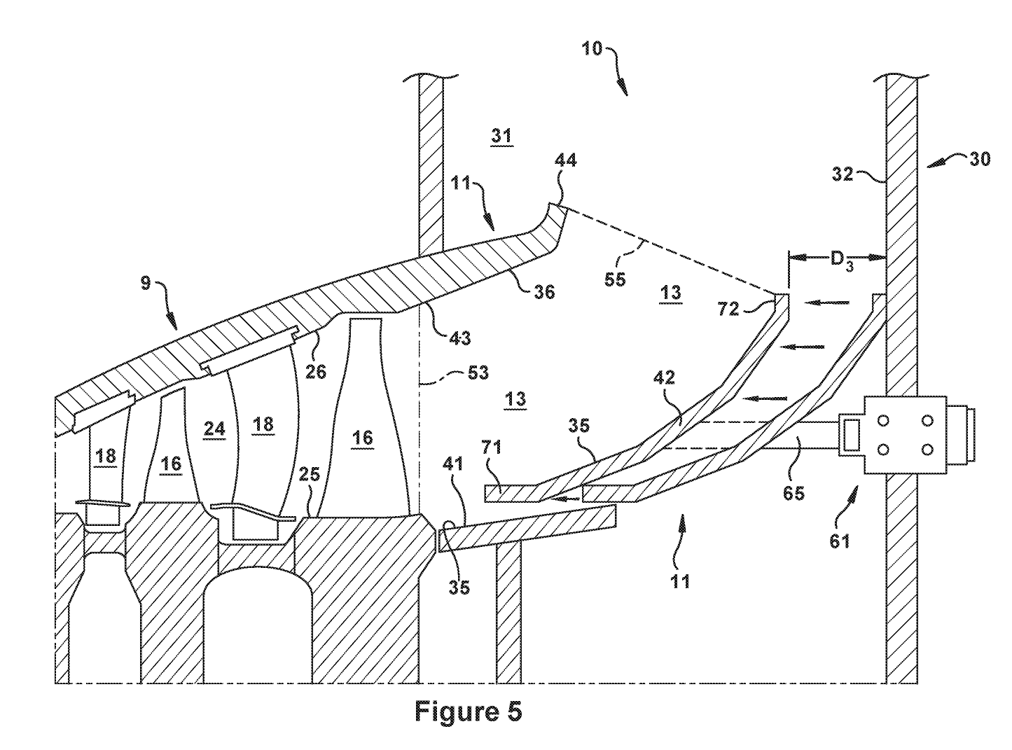

FIG. 5 simultaneously depicts both of the axial positions between which the adjustable wall may be moved via to modify the flow area through the diffuser. The stationary diffuser wall of the diffuser 11 may be defined as the axially defined section of the outboard wall 36 that forms a conical or truncated cone shape. The adjustable diffuser wall of the diffuser 11 may be defined as the axially defined section of the inboard wall 35 that forms a conical or truncated cone shape. Given these generally definitions, the outlet width dimension introduced above may be described as being defined between: the downstream end of the axially defined section of the outboard wall 36 that forms the conical or truncated cone shape; and the downstream end of the axially defined section of the inboard wall 35 that forms the conical or truncated cone shape. In moving between the two exemplary axial positions depicted, it is demonstrated how the present invention narrows the outlet width of the diffuser outlet 55 and, thereby, appreciably reduces the cross-sectional flow area through the diffuser flowpath 13. As further indicated in FIG. 5, movement between the two axial positions also may be marked relative to an axial offset that is created between the downstream end 72 of the downstream axial section 42 and the backwall 32 of the collector 30. Specifically, in the first position, it will be appreciated that the downstream end 72 of the downstream axial section 42 resides very near or against the backwall 32 of the collector 30. Whereas, in the second position, the downstream end 72 of the downstream axial section 42 is offset by a predetermined distance (D₃) from the backwall 32 of the collector 30.

As should also be appreciated in FIGS. 3 through 5, the axial repositioning of the adjustable wall brings the upstream end 71 of the downstream axial section 42 of the inboard wall 35 much closer to the inlet 53 of the diffuser 11, thereby narrowing the cross-sectional flow area within what is known as the exit area of the last row of rotor blades. This exit area, as previously explained, is the upstream portion of the diffuser flowpath 13, and represents the area within the diffuser 11 first encountered by the working fluid as it exits the last row of the rotor blades 16. Low volume flow conditions can cause the occurrence of recirculation in this area, which is particularly harmful to power output. The ability of the present invention to also narrow this portion of the diffuser flowpath 13 and, thereby, avoid such recirculation can boost power output considerably.

FIG. 6 illustrates calculated data at a range of exit velocities comparing performance characteristics during low exit velocity conditions between: 1) a conventional non-adjustable diffuser or a diffuser of the present invention operating in a conventional mode, i.e., with the downstream axial section of the inboard wall positioned fully in the downstream direction (which, in either case, will be referred to as “conventional diffuser 90”); and 2) a diffuser of the present invention with the downstream axial section of the inboard wall advantageously repositioned axially in the upstream direction (which will be referred to as “present diffuser 95”). FIG. 6 also provides a side-by-side cross-sectional comparison showing flow separation differences at low exit velocity conditions. As shown in relation to the conventional diffuser 90, at a low flow volume conditions—where the last stage of rotor blades has a low exit velocity—a high level of flow separation (see area indicated by arrow 91) takes place within the downstream axial section of the conventional diffuser 90. This leads to boundary layer growth and stall, which generally causes the exhaust flow to separate from the diffuser walls and causes pressure losses that degrade performance. However, in the case of the present diffuser 95, such flow separation is largely prevented due to the axial repositioning of the downstream axial section of the inboard wall, the upstream movement of which is indicated by arrows 96.

As shown in the plotted data of FIG. 6—in which a curve 92 depicts results for the conventional diffuser 90 and a curve 97 depicts the results achievable by the present diffuser 95—a significant performance benefit of about 4-6% additional power in the last stage rotor blade is possible. More specifically, included in the plotted data is an enthalpy recovery (“χ”) for the last stage of rotor blades over a range of exit velocities. As will be appreciated, the steep gradients occurring at low volume flow conditions indicate potentially sizeable gains are possible, and these are confirmed in the calculated data. Specifically, the performance benefit evidenced by the area between the curves 92, 97 at exit velocities below about 140 m/s is significant. As further indicated, as exit velocities increase above that 140 m/s threshold, the downstream axial section of the present invention can be relocated to its original position—thereby making the flow area through the flowpaths of the two diffusers 90, 95 equal—and, as expected, the data converges at these higher flow velocities. In this way, the present invention may be used to control the position of the adjustable wall in response to changing flow conditions so that high performance is maintained across a wider range of conditions. Specifically, at low volume flow and low exit velocity conditions, the flow area through the diffuser flowpath may be narrowed or reduced as described above, while at high volume and high exit velocity conditions, the flow area through the diffuser flowpath may be widened or increased to its original dimensions. In this way, the ability to manipulate the flow area through the diffuser flowpath may be used to reduce or eliminate flow separation and/or recirculation that would otherwise degrade performance.

For example, the present invention may include a method of operating a turbine engine. As before, the turbine engine may include a working fluid flowpath defined through a turbine section that operably connects to a diffuser flowpath defined through a diffuser, and the diffuser may include diffuser walls that define and enclose the diffuser flowpath between an inlet and outlet. The method may include the initial step of providing at least one stationary diffuser wall and at least one adjustable diffuser wall within the walls of the diffuser. As already described, the at least one adjustable diffuser wall may be one that is controllably adjustable or movable between at least a first position and a second position relative to the at least one stationary diffuser wall. (As will be appreciated, other potential embodiments of the present invention include the adjustable diffuser wall being adjustable between many other positions.) The second position may be one that reduces a cross-sectional flow area through a section of the diffuser flowpath—such as through the outlet and/or upstream portion of the diffuser flowpath—in comparison to the first position. The method may further include the step of sensing, via one or more sensors, a current value for an operating condition of the turbine engine and then comparing the current value to a threshold value. In response to the comparison, the method may include moving the at least one adjustable diffuser wall from the first position to the second position. As will be appreciated, the operating condition of the method may be one relating to flow volume or exit velocity through the turbine section, last row of rotor blades, or diffuser. Further, the step of comparing the current value to the threshold value may include making a determination as to whether the current value is less than the threshold value, with the threshold value serving as an indication that turbine engine is operating at a low flow volume or low exit velocity condition.

From the above description of preferred embodiments of the invention, those skilled in the art will perceive improvements, changes and modifications. Such improvements, changes and modifications within the skill of the art are intended to be covered by the appended claims. Further, it should be apparent that the foregoing relates only to the described embodiments of the present application and that numerous changes and modifications may be made herein without departing from the spirit and scope of the application as defined by the following claims and the equivalents thereof.

We claim:

1. A turbine engine comprising turbine section, through which a working fluid flowpath is defined, operably connected to an exhaust section, through which an exhaust flowpath is defined, such that a working fluid exiting the turbine section via the working fluid flowpath is ingested as exhaust via the exhaust flowpath of the exhaust section for flow therethrough, the exhaust section including a diffuser having a diffuser flowpath that defines an upstream portion of the exhaust flowpath, the turbine engine further comprising:
diffuser walls that define and enclose the diffuser flowpath between an inlet and outlet of the diffuser, the diffuser walls comprising at least one stationary diffuser wall and at least one adjustable diffuser wall; and
an actuator connected to the at least one adjustable diffuser wall;
wherein the actuator is configured to move the at least one adjustable diffuser wall in relation to the at least one stationary diffuser wall along an axis of movement that causes a modification to a cross-sectional flow area through the diffuser flowpath.

2. The turbine engine according to claim 1, wherein the working fluid and diffuser flowpaths each comprises an annular shaped flowpath defined between inboard and outboard walls, and wherein upstream and downstream directions through the working fluid flowpath and the exhaust flowpath are defined in relation to flow directions therethrough of the working fluid and the exhaust, respectively; and
wherein the inboard and outboard walls of the annular shaped flowpath of each of the working fluid and diffuser flowpaths are arranged concentrically about a central axis that is defined through a central shaft of the turbine engine.

3. The turbine engine according to claim 2, wherein the at least one stationary diffuser wall of the diffuser walls comprises the outboard wall of the diffuser; and
wherein the at least one adjustable diffuser wall of the diffuser walls comprises the inboard wall of the diffuser.

4. The turbine engine according to claim 3, wherein the outlet of the diffuser is defined between a downstream most end of the outboard wall of the diffuser and a downstream most end of the inboard wall of the diffuser;
wherein the actuator is configured to move the at least one adjustable diffuser wall between at least a first and second position, wherein:
the first position comprises the downstream most end of the inboard wall of the diffuser residing a first distance from the downstream most end of the outboard wall of the diffuser; and
the second position comprises the downstream most end of the inboard wall of the diffuser residing a second distance from the downstream most end of the outboard wall of the diffuser;
wherein the first distance is at least 1.25 times the second distance.

5. The turbine engine according to claim 3, wherein the axis of movement comprises an axial direction in relation to the central axis;
wherein the inboard wall of the diffuser walls comprises an axially defined section in the form of a truncated cone that expands in the downstream direction between a smaller diameter at an upstream end and a larger diameter at a downstream end;
wherein the outboard wall of the diffuser walls comprises an axially defined section in the form of a truncated cone that expands in the downstream direction between a smaller diameter at an upstream end and a larger diameter at a downstream end; and
wherein:
the at least one stationary diffuser wall of the diffuser walls comprises the axially defined section of the outboard wall in the form of a truncated cone; and
the at least one adjustable diffuser wall of the diffuser walls comprises the axially defined section of the inboard wall in the form of a truncated cone.

6. The turbine engine according to claim 5, wherein the outlet of the diffuser is defined by an outlet width that is measured between the downstream end of the axially defined section of the outboard wall and the downstream end of the axially defined section of the inboard wall; and
wherein the modification to the cross-sectional flow area through the diffuser flowpath comprises a reduction in the outlet width of the outlet of the diffuser.

7. The turbine engine according to claim 5, wherein the turbine section comprises a last row of rotor blades just upstream of the inlet of the diffuser;
wherein an exit area of the last row of rotor blades is defined as an upstream portion of the diffuser flowpath that accepts the working fluid exiting the last row of the rotor blades; and
wherein the modification to the cross-sectional flow area through the diffuser flowpath comprises a narrowing of the cross-sectional flow area within the exit area of the last row of rotor blades.

8. The turbine engine according to claim 3, wherein the inboard wall of the diffuser walls comprises axially defined sections in which an upstream axial section resides in the upstream direction relative to a downstream axial section;
wherein the downstream axial section comprises a truncated cone shape; and
wherein:
the at least one stationary diffuser wall of the diffuser walls comprises the outboard wall of the diffuser walls and the upstream axial section of the inboard wall of the diffuser walls; and
the at least one adjustable diffuser wall of the diffuser walls comprises the downstream axial section of the inboard wall of the diffuser walls.

9. The turbine engine according to claim 8, wherein the axis of movement comprises an axial direction in relation to the central axis;
wherein the upstream axial section of the inboard wall comprises a truncated cone shape; and
wherein the downstream axial section of the inboard wall is canted in relation to the central axis, the downstream axial section angling in an outer radial direction as the downstream axial section extends in the downstream direction between an upstream end and downstream end.

10. The turbine engine according to claim 8, wherein the truncated cone shape of the downstream axial section of the inboard wall is radially symmetrical about a longitudinal axis defined approximately at the central axis, the truncated cone shape enlarging in diameter between a smaller diameter end and a larger diameter end; and
wherein:
an upstream end of the downstream axial section of the inboard wall comprises the smaller diameter end of the truncated cone shape; and
a downstream end of the downstream axial section of the inboard wall comprises the larger diameter end of the truncated cone shape.

11. The turbine engine according to claim 10, wherein the outlet of the diffuser is defined by an outlet width that is measured between a downstream end of the outboard wall and the downstream end of the downstream axial section of the inboard wall; and
wherein the modification to the cross-sectional flow area through the diffuser flowpath comprises a reduction in the outlet width of the outlet of the diffuser.

12. The turbine engine according to claim 10, wherein the downstream end of the outboard wall comprises a flared lip.

13. The turbine engine according to claim 10, wherein the actuator is configured to move the downstream axial section of the inboard wall between at least a first position and a second position so to achieve the reduction in the outlet width of the outlet of the diffuser;
wherein:
at the first position, the outlet width comprises a first distance;
at the second position, the outlet width comprises a second distance;
wherein the first distance is at least 1.25 times the second distance.

14. The turbine engine according to claim 11, wherein the exhaust section further comprises a collector through which a collector flowpath is defined, the collector flowpath comprising a downstream portion of the exhaust flowpath that is configured to receive the exhaust exiting the outlet of the diffuser;
wherein the collector comprises a backwall that approximately opposes the outlet of the diffuser, the backwall being oriented approximately perpendicular to the central axis for deflecting the exhaust exiting the outlet of the diffuser in a direction that is approximately perpendicular to the central axis.

15. The turbine engine according to claim 14, wherein the outboard wall of the diffuser walls comprises a truncated cone shape that is radially symmetrical about a longitudinal axis defined approximately at the central axis;
wherein the truncated cone shape of the outboard wall enlarges in diameter between a smaller diameter end and a larger diameter end; and
wherein:
an upstream end of the outboard wall comprises the smaller diameter end of the truncated cone shape of the outboard wall; and
the downstream end of the outboard wall comprises the larger diameter end of the truncated cone shape of the outboard wall.

16. The turbine engine according to claim 15, wherein the upstream axial section of the inboard wall extends between an upstream end, which is disposed adjacent to the inboard wall of the working fluid flowpath, and a downstream end, which is disposed adjacent to the downstream axial section;
wherein the downstream axial section of the inboard wall extends between an upstream end, which is disposed adjacent to the upstream axial section of the inboard wall, and the downstream end; and
wherein the outboard wall extends between an upstream end, which is adjacent to the outboard wall of the working fluid flowpath, and the downstream end.

17. The turbine engine according to claim 16, wherein the outlet of the diffuser is defined by an outlet width that is measured between the downstream end of the outboard wall and the downstream end of the downstream axial section of the inboard wall; and
wherein the modification to the cross-sectional flow area through the diffuser flowpath comprises a reduction in the outlet width of the outlet of the diffuser.

18. The turbine engine according to claim 17, wherein the turbine engine comprises a steam turbine engine;
wherein the actuator is configured to move the at least one adjustable diffuser wall between at least a first and second position; and
wherein:
the first position comprises the downstream end of the downstream axial section of the inboard wall residing adjacent to the backwall of the collector; and
the second position comprises the downstream end of the downstream axial section of the inboard wall residing a predetermined distance offset from the backwall of the collector.

19. A method of operating a turbine engine, the turbine engine comprising a working fluid flowpath defined through a turbine section that is operably connected to a diffuser flowpath defined through a diffuser, wherein the diffuser comprises diffuser walls that define and enclose the diffuser flowpath between an inlet and outlet of the diffuser, the method comprising the steps of:
providing at least one stationary diffuser wall of the diffuser walls;
providing at least one adjustable diffuser wall of the diffuser wall, wherein the at least one adjustable diffuser wall is controllably movable between at least a first position and a second position relative to the at least one stationary diffuser wall, wherein the second position comprises a reduction in a flow area through the outlet of the diffuser compared to the first position;
via one or more sensors, sensing a current value for an operating condition of the turbine engine;
comparing the current value of the operating condition to a threshold value;
in response to the comparison, moving the at least one adjustable diffuser wall from the first position to the second position.

20. The method according to claim 19, wherein the operating condition comprises a flow volume through the turbine section;
wherein the step of comparing comprises a determination if the current value of the flow volume is less than the threshold value; and
wherein the diffuser flowpath comprises an annular shaped flowpath defined between inboard and outboard walls, and wherein the at least one adjustable wall of the diffuser walls comprises a conically shaped axially defined section of the inboard wall.
